(19) United States
(12) Patent Application Publication
(10) Pub. No.: US 2024/0228796 A1
(43) Pub. Date: Jul. 11, 2024

(54) SUBSTRATE COMPRISING A SURFACE COVERED WITH AN EPILAME AGENT AND METHOD FOR EPILAME-COATING SUCH A SUBSTRATE

(71) Applicant: The Swatch Group Research and Development Ltd, Marin (CH)

(72) Inventors: Mathieu AYER, Neyruz (CH); Christophe LETONDOR, Le Landeron (CH)

(73) Assignee: The Swatch Group Research and Development Ltd, Marin (CH)

(21) Appl. No.: 18/536,861

(22) Filed: Dec. 12, 2023

(30) Foreign Application Priority Data
Dec. 29, 2022 (EP) 22217090.4

(51) Int. Cl. C09D 5/16; A44C 27/00; C08F 220/28; C09D 133/16

(52) U.S. Cl. CPC C09D 5/1668; A44C 27/007; C08F 220/286; C09D 133/16; C08F 2800/10

(57) ABSTRACT

A substrate comprising a surface at least a portion of which is covered with an epilame agent, comprising at least one compound in the form of a copolymer comprising units M and units N, associated by covalent bonds via their main chains, where

M is

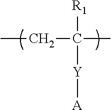

N is

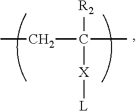

where R₁ and R₂, which may be identical or different, are H, a C₁-C₁₀ alkyl group, a C₂-C₁₀ alkenyl group; X and Y, which may be identical or different, are spacer arms consisting of a heteroatom or a linear or branched hydrocarbon chain containing at least one heteroatom and comprising at least one carbon atom; A, which may be identical or different, forms an anchoring group to the substrate; L, which may be identical or different, is a halogenated ether group according to formula (I)

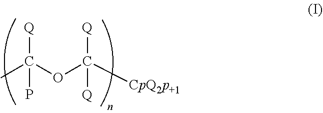

where Q is a halogen atom; P, which may be identical or different, is a C₁-C₁₀ alkyl group or a C₂-C₁₀ alkenyl group comprising at least one halogen atom and being linear or branched; p is chosen between 1 and 4; and n is chosen between 1 and 20.

### CROSS REFERENCE TO RELATED APPLICATIONS

This application claims priority to European Patent Application No. 22217090.4 filed Dec. 29, 2022, the entire contents of which are incorporated herein by reference.

### TECHNICAL FIELD OF THE INVENTION

The present invention relates to a substrate comprising a surface at least a portion of which is covered with an epilame agent. The invention also relates to methods for epilame-coating such a substrate.

### Technological Background

There are various methods for modifying the surface condition of a substrate by treatment with an appropriate agent in order to specifically improve certain surface properties. For example, in the field of mechanics, and in particular in the field of watchmaking, but also in the field of jewellery, the epilame-coating of a surface of a part or element is often carried out by means of an epilame agent in order to control and reduce the surface energy of said surface during its use. More specifically, the purpose of an epilame agent is to prevent oils or lubricants from spreading on the elements of a timepiece or a piece of jewellery by forming a hydrophobic and oleophobic surface allowing the lubricant to remain at a predetermined location on the treated surface.

However, the substances currently used for epilame-coating have a number of disadvantages. For example, epilame agents such as Fixodrop® ES/BS from Moebius® or of the Novec™ range from 3M™ are not resistant enough to watchmaking washes.

Patent application US2012/0088099 provides a partial solution to this problem by proposing the use of an epilame agent carrying a catechol function at the end of the chain. This catechol function is capable of attaching firmly to the surface of certain substrates, but does not offer improved resistance to watchmaking washings for substrates such as gold and steel, which are very common substrates in the watchmaking or jewellery field. As a result, the use of known epilame agents is generally limited to certain materials, requiring the user to have different types of epilame agents available depending on the nature of the surfaces to be treated.

One solution to this problem is described, for example, in patent application WO 2012/085130. This solution consists in using as the epilame composition a mixture of compounds of different natures (thiol and biphosphonic) whose synergistic effect promotes adhesion of the epilame to the substrate. However, the synthesis of each of these compounds requires at least four steps, so that the synthesis method for the epilame composition as a whole is long and complex.

Another solution is described for example in patents EP 3 070 133 and EP 3 070 152. Patent EP 3 070 133 describes an epilame agent comprising a random copolymer comprising a fluorinated motif, an anchoring motif and optionally an additional hydrocarbon chain. EP 3 070 152 describes an epilame agent comprising a block copolymer comprising a fluorinated motif, an anchoring motif and optionally an additional hydrocarbon chain. In particular, fluorinated motifs of the type —C₅F₁₁ and —C₆F₁₃ are described.

Nevertheless, perfluorohexanoic acid (PFHxA, CAS 307-24-4), its salts and related substances are under general regulatory pressure for environmental reasons.

### SUMMARY OF THE INVENTION

The purpose of the invention is in particular to overcome the various disadvantages of known epilame agents and epilame-coating methods.

More specifically, a purpose of the invention is to provide an epilame agent that is considered not to be under general regulatory pressure for environmental reasons.

It is also a purpose of the invention to provide an epilame agent with increased wash resistance compared with known epilame agents. It is also the purpose of the invention to provide a universal epilame agent that can be used for any type of material.

Another purpose of the invention is to provide an environmentally friendly epilame-coating method allowing to eliminate the use of a large amount of polluting fluorinated solvents. Another purpose of the invention is to provide an economical epilame-coating method that allows to eliminate the use of a large amount of expensive fluorinated solvents.

Another purpose of the invention is to provide an epilame agent and an epilame-coating method that allow to accurately determine the concentration of epilame agent over time, in order to make the overall epilame-coating method more robust.

To this end, a first aspect of the present invention relates to a substrate comprising a surface at least a portion of which is covered with an epilame agent according to the appended claims.

According to the invention, the epilame agent comprises at least one compound in the form of a copolymer comprising units M and units N. These units M and units N are associated by covalent bonds via their main chains.

According to the invention, M is

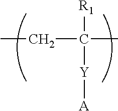

where
R₁, which may be identical or different, is H, a C₁-C₁₀ alkyl group, or a C₂-C₁₀ alkenyl group, and preferably H or CH₃,
Y, which may be identical or different, is a spacer arm consisting of a heteroatom or a linear or branched hydrocarbon chain containing at least one heteroatom, comprising at least one carbon atom, and
A, which may be identical or different, forms an anchoring group to the substrate.

Advantageously, Y, which may be identical or different, is selected from the group comprising C₁-C₂₀ ester groups, amide groups and groups derived from styrene. Optionally, Y, which may be identical or different, comprises at least one heteroatom.

Advantageously, A is selected from the group comprising glycidyl, thiols, thioethers, thioesters, sulphides, thioamides, silanols, alkoxysilanes, silane halides, hydroxyls, phosphates, protected or unprotected phosphonic acids, protected or unprotected phosphonates, amines, ammoniums, nitrogen heterocycles, carboxylic acids, anhydrides and catechols.

According to the invention, N is

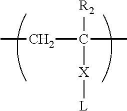

where
R₂, which may be identical or different, is H, a C₁-C₁₀ alkyl group, or a C₂-C₁₀ alkenyl group, and preferably H or CH₃,
X, which may be identical or different, is a spacer arm consisting of a heteroatom or a linear or branched hydrocarbon chain containing at least one heteroatom, comprising at least one carbon atom, and
L, which may be identical or different, is a halogenated ether group according to formula (I)

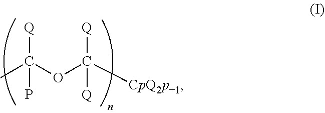

where
Q is a halogen atom,
P, which may be identical or different, is a C₁-C₁₀ alkyl group or a C₂-C₁₀ alkenyl group comprising at least one halogen atom and being linear or branched,
p is chosen between 1 and 4, preferably between 2 and 3, and
n is chosen between 1 and 20, for example between 1 and 16, preferably between 1 and 10.

Advantageously, X, which may be identical or different, is selected from the group comprising C₁-C₂₀ ester groups, amide groups and groups derived from styrene. Optionally, X, which may be identical or different, comprises at least one heteroatom.

Advantageously, L is an ether group which is at least a partially fluorinated, for example totally fluorinated. The term “totally fluorinated” as used in the present disclosure indicates an ether group wherein each hydrogen atom is replaced by a fluorine atom.

Advantageously, the copolymer is a random copolymer. Advantageously, the units M and the units N are distributed randomly. Advantageously, the copolymer is a random copolymer and the units M and the units N are distributed randomly.

Alternatively, and also advantageously, the copolymer is a block copolymer. Advantageously, the block copolymer comprises at least one block of units M associated by covalent bonds via their main chains, and at least one block of units N associated by covalent bonds via their main chains. Advantageously, the blocks are bound together by covalent bonds via their main chains in linear sequences.

Advantageously, the units N/units M ratio is between 1 and 20, for example between 2 and 18, or between 5 and 15.

Advantageously, and optionally, the copolymer according to the present disclosure further comprises units V. Advantageously, the units V are associated with the units M and N by covalent bonds via their main chains. Advantageously, V is

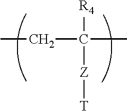

where
R₄, which may be identical or different, is H, a C₁-C₁₀ alkyl group, a C₂-C₁₀ alkenyl group, preferably H or CH₃,
Z, which may be identical or different, is a spacer arm consisting of a heteroatom or a linear or branched hydrocarbon chain containing at least one heteroatom, comprising at least one carbon atom, and
T, which may be identical or different, is a tracer group arranged to determine the concentration of epilame agent in an epilame-coating bath.

Advantageously, T, which may be identical or different, is a UV absorber group or a fluorophore.

Advantageously, the surface of the substrate, at least a portion of which is covered with the epilame agent, is made of a material selected from the group comprising metals, metal oxides, polymers, sapphire, ruby, silicon, silicon oxides, silicon nitrides, silicon carbides, diamond like carbon (DLC) and alloys thereof.

A second aspect of the present invention relates to a method for epilame-coating at least a portion of a surface of a substrate according to the appended claims.

The epilame-coating method according to the present invention comprises preparing an epilame agent comprising at least one copolymer as defined above. Optionally, the epilame-coating method further comprises preparing the surface of the substrate. The epilame-coating method further comprises contacting the surface of the substrate with the epilame agent.

Advantageously, the epilame agent is prepared (the preparation of the epilame agent is carried out) by copolymerisation of monomers capable of forming the units M with monomers capable of forming the units N. Advantageously, the units M and the units N are as described above. Advantageously, the monomers are selected from the group comprising acrylate, methacrylate, acrylamide, methacrylamide, vinyl and styrene monomers.

According to one embodiment of the epilame-coating method, the epilame agent is prepared by preparing an epilame-coating bath containing the epilame agent. Then, at least a portion of the surface of the substrate is contacted with the epilame agent in the epilame-coating bath, for example by immersing the substrate in the epilame-coating bath.

This preparation of the epilame agent is particularly suitable when the epilame agent comprises at least one copolymer additionally comprising units V associated with the units M and N by covalent bonds via their main chains. Advantageously, the units V are as described above. The presence of the units V, and in particular of the tracer group, advantageously and optionally allows to control the concentration of epilame agent in the epilame-coating bath before contacting. Optionally, and after controlling the concentration of the epilame agent, the concentration of epilame agent in the epilame-coating bath can be readjusted.

According to another embodiment of the epilame-coating method, the surface of the substrate is contacted with the epilame agent by placing the substrate and epilame agent in an enclosure at ambient pressure, followed by hermetically sealing the enclosure. Next, CO₂ at a pressure comprised between 25 bar and 74 bar, preferably between 45 bar and 70 bar, and at a temperature comprised between 10° C. and 80° C., preferably between 15° C. and 50° C., is introduced into the hermetically sealed enclosure. The pressure in the enclosure is then reduced and the epilame-coated substrate is removed from the enclosure.

A third aspect of the present invention relates to the use of a copolymer comprising units M and units N, associated by covalent bonds through their chains, as an epilame agent of at least a portion of a surface of a substrate. The units M and the units N are as described above.

The present invention further relates to a timepiece or a piece of jewellery comprising an element including a substrate according to the first aspect of the present invention.

One of the advantages of epilame agents according to the present invention is that they are not under regulatory pressure for environmental reasons, although they offer a high-performance epilame effect. Another advantage is that they are resistant to washing, particularly watchmaking washing.

### BRIEF DESCRIPTION OF THE FIGURES

The aims, advantages and features are demonstrated in the following figures, which are not limiting, and wherein:

FIG. 1 shows the structure of a perfluoroether monomer,

FIG. 2 shows the structure of a monomer comprising an anchoring group,

FIG. 3 shows the structure of an epilame copolymer according to the invention,

FIG. 4 shows the contact angles measured on different substrates whose surface is covered with an epilame agent according to the invention,

FIG. 5 shows the contact angles measured on different substrates whose surface is covered with a C₆F₁₃ type epilame agent,

FIG. 6 shows the contact angles measured on different substrates whose surface is covered with a competing epilame agent.

### DETAILED DESCRIPTION OF THE INVENTION

In accordance with the present invention, a substrate comprises a surface at least a portion of which is covered with an epilame agent. Advantageously, at least the surface of the substrate, and optionally the entire substrate, is made of a material selected from the group comprising metals, metal oxides, polymers, sapphire, ruby, silicon, silicon oxides, silicon nitrides, silicon carbides, diamond like carbon (DLC), and alloys thereof.

More specifically, the surface of the substrate can comprise or be made of steel, or noble metals such as gold, rhodium, palladium, platinum, or combinations of two or more thereof, or metal oxides, whether or not doped with aluminium, zirconium, titanium, chromium, manganese, magnesium, iron, nickel, copper, zinc, molybdenum, silver, tungsten, or combinations of two or more thereof, or polyoxymethylene or acrylamide, as well as their alloys.

Advantageously, in the present invention, the substrate is a substrate of an element of a timepiece or a piece of jewellery.

Advantageously, the group X, which may be identical or different, is selected from the group comprising C₁-C₂₀ ester groups, preferably C₂-C₁₀ ester groups, more preferably C₂-C₆ ester groups and even more preferably C₂-C₅ ester groups, preferably linear alkyl ester groups, amide groups and groups derived from styrene.

Advantageously, the group Y, which may be identical or different, is selected from the group comprising C₁-C₂₀, preferably C₂-C₁₀, more preferably C₂-C₆, and even more preferably C₂-C₅ ester groups, preferably alkyl ester groups, which are preferably linear, amide groups and groups derived from styrene.

Advantageously, the copolymer comprises at least two different groups A. The functional groups of interest A are capable of reacting with the surface of the substrate to be epilame-coated, so as to form groups for anchoring the epilame agent on the surface of the substrate. Advantageously, groups A can also be provided at the end of the copolymer.

The functional groups of interest L are responsible for the epilame effect. They comprise at least one halogen atom Q. Advantageously, the halogen atom Q, which may be identical or different, is a fluorine atom, an iodine atom, a bromine atom or a chlorine atom. Preferably, the halogen atom is a fluorine atom. If group L comprises several halogen atoms, the atoms may be identical or different. Advantageously, all the halogen atoms Q in group L are fluorine atoms.

The functional groups of interest L also comprise a group P. The group P, which may be identical or different, is advantageously a C₁-C₁₀ alkyl group, a C₂-C₁₀ alkenyl group or a C₂-C₁₀ alkynyl group. The group P advantageously comprises at least one halogen atom. Advantageously, the halogen atom, which may be identical or different, is a fluorine atom, an iodine atom, a bromine atom or a chlorine atom. Preferably, the halogen atom is a fluorine atom. The group P may be linear or branched.

Advantageously, the group P is a C₁-C₁₀ perfluoroalkyl group, preferably a C₁-C₆ perfluoroalkyl group, for example a C₁-C₄ perfluoroalkyl group, such as CF₃, C₂F₅, C₃F₇ or C₄F₉.

Advantageously and alternatively, the group P is a C₂-C₁₀ perfluoroalkenyl group, preferably a C₂-C₆ perfluoroalkenyl group, for example a C₂-C₄ perfluoroalkenyl group, such as C₂F₃, C₃F₅ and C₄F₇.

Advantageously and alternatively, the group P is a C₂-C₁₀ perfluoroalkynyl group, preferably a C₂-C₆ perfluoroalkynyl group, for example a C₂-C₄ perfluoroalkynyl group, such as C₂F, C₃F₃, and C₄F₅.

Advantageously, in the functional group of interest L, p is chosen between 1 and 4, preferably between 2 and 3.

Advantageously, in the functional group of interest L, n is chosen between 1 and 20, for example between 1 and 16, preferably between 1 and 10, for example between 2 and 8.

A preferred functional group of interest L in the present invention is represented by the structure (CF(CF₃)OCF₂)ₙCF₂CF₃, that is to say Q is a fluorine (F) atom, P is CF₃, and p is 2. More particularly, a preferred structure of the group L is (CF(CF₃)OCF₂)₅CF₂CF₃, that is to say Q is a fluorine (F) atom, P is CF₃, p is 2, and n is 5.

One of the copolymers preferably used in the present invention has the following structure (II)

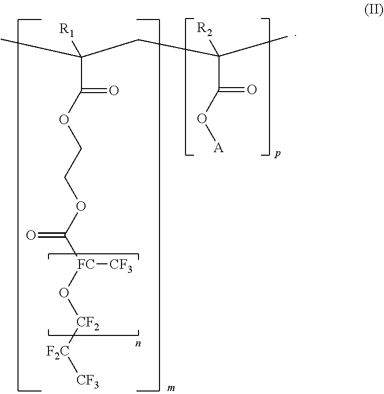

In other words, in this copolymer X is C(O)O(CH₂)₂OC(O); Y is C(O)O; P is fluorine (F); Q is CF₃; and p is 2, indicating that L is (CF(CF₃)OCF₂)ₙCF₂CF₃. Preferably, in the copolymer represented by structure (II), R₁ and R₂, which may be identical or different, are H or CH₃.

A particular example of this copolymer presented by structure (II), without limitation, is a copolymer wherein n is 5, R₁ is H, R₂ is CH₃, A is CH₂(CHCH₂O), and the m/p ratio is 9.

Optionally, the copolymer can further comprise at least one unit U, where U is

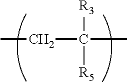

where
R₃, which may be identical or different, is H, a C₁-C₁₀ alkyl group, or a C₂-C₁₀ alkenyl group, and preferably H or CH₃, and
R₅, which may be identical or different, is H, CH₃, a linear or branched, saturated or unsaturated hydrocarbon chain which may contain at least one heteroatom, comprising at least 2 carbon atoms.

Advantageously, when the copolymer comprises at least one unit U, the unit U and the units M and the units N are associated by covalent bonds via their main chains.

Advantageously, the functional groups of interest R₅ allow to modify the properties of the epilame agent and/or to provide other functions. For example, R₅ may be an alkyl chain used to modify the contact angle obtained, or may be a chain capable of forming cross-linking points during a complementary cross-linking step.

Advantageously, the units N/units M ratio is between 1 and 20, preferably between 2 and 18, for example between 5 and 15, or between 7 and 12, for example 8, 9, 10 or 11.

Advantageously, the copolymer comprises between 0.1% and 50%, preferably between 5% and 30%, and more preferably between 5% and 20% of units M, the percentage being expressed with respect to the total number of units in the copolymer. Advantageously, the copolymer comprises between 1% and 99.9%, preferably between 50% and 99.9%, and more preferably between 80% and 95% units N, the percentage being expressed with respect to the total number of units in the copolymer. Advantageously, the copolymer comprises between 0% and 50%, preferably between 0% and 30%, and more preferably between 0% and 10% of units U, the percentage being expressed with respect to the total number of units in the copolymer.

Optionally, the copolymer can further comprise at least one unit V, where V is as described above. Advantageously, when the copolymer comprises at least one unit V, the unit V and the units M and the units N are associated by covalent bonds via their main chains.

Advantageously, the group Z, which may be identical or different, is selected from the group comprising C₁-C₂₀ ester groups, preferably C₂-C₁₀ ester groups, more preferably C₂-C₆ ester groups and even more preferably C₂-C₅ ester groups, preferably linear alkyl ester groups, amide groups and groups derived from styrene.

Advantageously, the group T can be used, for example, to determine the copolymer concentration by spectroscopy.

Advantageously, T, which may be identical or different, is a UV absorber group derived from a compound selected from the group comprising benzotriazoles, triazines, phenones (in particular benzophenone, acetophenone, hydroxyalkylphenone, hydroxyarylphenone, aminoalkylphenone and anthraquinone) and acylphosphine oxides.

Advantageously, T, which may be identical or different, is a fluorophore group derived from a compound selected from the group comprising fluoroscein, naphthyl, anthracene, coumarin, rhodamine and a fluorobenzoate.

Advantageously, the copolymer comprises between 5 and 500 units, preferably between 10 and 350 units.

The copolymer may be a random copolymer or a block copolymer.

Advantageously, when the copolymer is a random copolymer, the units M, N, the optional units V and the optional units U are distributed randomly. In other words, the units are bound together statistically via their main chain.

Advantageously, when the copolymer is a block copolymer, the copolymer comprises at least one block of units M associated by covalent bonds via their main chains, and at least one block of units N associated by covalent bonds via their main chains. Preferably, the block copolymer comprises a single block of units M and/or a single block of units N.

Optionally, the block copolymer further comprises at least one block of units V associated by covalent bonds via their main chains. Preferably and optionally, the block copolymer comprises a single block of units V.

Optionally, at least one of the block of units M, the block of units N and the optional block of units V optionally comprises at least one unit U, associated by covalent bonds via their main chains. Advantageously, the blocks are bound together by covalent bonds via their main chains in linear sequences. If the block copolymer further comprises at least one unit U, at least one of the block of units M, the block of units N and the optional block of units V comprises at least one unit U, and the number of units U in the block of units M may vary by the number of units U in the block of units N and the number of units U in the block of units V if the latter is comprised in the block copolymer.

Preferably, the units U are integrated and distributed within the block composed of units N, for example by statistical copolymerisation of units U with units N to form a single block composed mainly of units N and assimilated to a block of units N.

The invention also relates to a method for epilame-coating at least a portion of a surface of a substrate comprising preparing an epilame agent, optionally preparing the surface of the substrate, and contacting the surface of the substrate with the epilame agent.

Advantageously, the preparation of the epilame agent comprises the copolymerisation of monomers capable of forming the units M with monomers capable of forming the units N, optionally monomers capable of forming at least one unit V, and optionally monomers capable of forming at least one unit U.

Advantageously, the monomers are selected from the group comprising acrylate, methacrylate, acrylamide, methacrylamide, vinyl, diene, styrene and olefin monomers.

Particularly preferred monomers for forming units V comprising a tracer group T are selected from the group comprising 2-H-benzotriazole-2-yl-hydroxyphenyl ethyl methacrylate, 2-(2H-benzotriazol-2-yl)-4-methyl-6-(2-propenyl)phenol, 2-(4-benzoyl-3-hydroxyphenoxy)ethyl acrylate, 4-allyloxy-2-hydroxybenzophenone, 2-naphthyl (meth)acrylate, fluorescein O-(meth)acrylate, 9-anthracenylmethyl (meth)acrylate, ethidium bromide-N,N′-bisacrylamide, N-(1-naphthyl)-N-phenylmethacrylamide, and 7-[4-(trifluoromethyl) coumarin] methacrylamide. Such monomers are commercially available and polymerisable.

Even more preferably, the monomers for forming the units V comprising a tracer group T are selected from the group comprising 2-H-benzotriazole-2-yl-hydroxyphenyl ethyl methacrylate, 2-(2H-benzotriazol-2-yl)-4-methyl-6-(2-propenyl)phenol, 2-(4-benzoyl-3-hydroxyphenoxy)ethyl acrylate and 4-allyloxy-2-hydroxybenzophenone. These monomers include tracer groups that can be monitored by UV-visible spectroscopy, which is much easier to set up in an industrial environment than fluorescence spectroscopy.

Polymerisation techniques comprise those known to the person skilled in the art. Optionally, the copolymerisation is carried out in the presence of an initiator, such as, without limitation, azobisisobutyronitrile (AIBN). Optionally, the copolymerisation is carried out at a high temperature.

The copolymers used in this invention can be obtained in powder or viscous liquid form.

A particularly suitable polymerisation method for obtaining a random copolymer is free radical copolymerisation, in solution or emulsion.

A particularly suitable polymerisation method for obtaining a block copolymer is successive controlled radical copolymerisation:
of monomers capable of forming at least one block of units M and optionally with monomers capable of forming at least one unit U,
of monomers capable of forming at least one block of units N and optionally with monomers capable of forming at least one unit U, U being identical or different, and
optionally of monomers capable of forming at least one block of units V and optionally with monomers capable of forming at least one unit U, U being identical or different.

According to a first copolymerisation mode, the copolymer can be obtained in a single step by copolymerisation, preferably radical copolymerisation, of monomers bearing side chains Y-A with monomers bearing side chains X-L, optionally monomers bearing side chains Z-T, and optionally monomers bearing side chains R₅.

According to another copolymerisation method, the copolymer can be obtained by copolymerisation, preferably radical copolymerisation, of monomers bearing suitable side chains Y with monomers bearing suitable side chains X, optionally monomers bearing suitable side chains Z and optionally monomers bearing side chains intended to carry R₅, then the side chains are modified, for example by “click chemistry”, to introduce the functional groups of interest A, L, T (optionally), and the groups R₅ (optionally) therein.

Advantageously, when the copolymerisation is a radical copolymerisation, the radical copolymerisation is of the “free” type in order to obtain a random copolymer. Advantageously, the radical copolymerisation is of the “controlled” type in order to obtain a block copolymer.

Optional preparation of the surface of the substrate may include cleaning and/or washing the surface to be epilame-coated. Such cleaning or washing may be carried out using methods known to the person skilled in the art. For example, and in particular when the substrate is a watch component, the cleaning may include cleaning according to standard watchmaking methods.

Alternatively, preparation of the surface of the substrate may include treatment with CO₂ at a temperature comprised between 10° C. and 80° C. and a pressure comprised between 25 bar and 250 bar, for example for a period comprised between 1 min and 60 min. Advantageously, such a treatment allows to remove particulate dust and to degrease the surface.

Advantageously, the copolymer or copolymers are dissolved in a fluorinated solvent, such as perfluorinated or fluorinated hydrocarbons, perfluoropolyethers, hydrofluoroolefins or hydrofluoroethers, at concentrations preferably comprised between 50 mg/L and 1 g/L, in order to obtain an epilame agent solution.

According to a first embodiment of the epilame-coating method, such an epilame agent solution is then used in an epilame-coating bath. The same epilame-coating bath can be used several times. Advantageously, when the same epilame-coating bath is used several times, means for controlling and optionally means for maintaining the concentration of the epilame agent are present in order to control and optionally maintain this concentration over time, and preferably before contacting the surface of the substrate with the epilame agent in the epilame-coating bath.

Such concentration control means may include the presence of at least one unit V as described above in the copolymer. In other words, the presence of at least one unit V comprising a group T as described above allows to control the concentration of epilame agent in the epilame-coating bath.

Advantageously, when the group T is a UV absorber group or a fluorophore, the concentration of epilame agent is determined by spectroscopy (absorbance measurement, for example). An intermediate step, prior to the step of controlling the concentration of the epilame agent in the epilame-coating bath, provides for producing a calibration curve for the copolymer. For this purpose, the copolymer is dissolved at different concentrations in a solvent, and for each solution the absorbance is measured by spectroscopy as a function of wavelength. The wavelength at which absorbance is at a maximum is identified and the calibration curve A=F(concentration) is plotted at the wavelength at which absorbance is at a maximum. The molar extinction coefficient of the polymer can then be deduced (Beer Lambert's law A=εcl).

To control the concentration of the epilame agent in the epilame-coating bath, it is then sufficient to measure the absorbance of the bath solution spectroscopically, then deduce the concentration of the epilame agent in the bath using the calibration curve previously established. Depending on the result, additional epilame agent can then be added to the bath to precisely adjust the concentration.

After the surface of the substrate has been contacted with the epilame agent, the epilame-coating method according to the invention can further comprise a step of drying the epilame-coated surface.

According to a second embodiment of the epilame-coating method, the epilame agent solution as described above is used (including placed) in an enclosure. Alternatively, the epilame agent can be placed in the enclosure in pure form.

Advantageously, the substrate and the epilame agent are placed in an enclosure at ambient pressure, that is to say a pressure comprised between 0.6 bar and 1.1 bar, followed by hermetic closure of the enclosure.

CO₂ is then introduced into the hermetically sealed enclosure. Advantageously, the CO₂ is introduced for a period comprised between 1 min and 30 min, preferably between 1 min and 20 min, and more preferably between 3 min and 15 min.

Advantageously, the CO₂ is at a pressure comprised between 25 bar and 74 bar, preferably between 45 bar and 70 bar, and more preferably between 50 bar and 60 bar.

Advantageously, the CO₂ is at a temperature comprised between 10° C. and 80° C., preferably between 10° C. and 60° C., and more preferably between 15° C. and 50° C.

The introduction of CO₂ is then stopped and the pressure in the enclosure is reduced. Advantageously, the pressure is reduced to ambient pressure, that is to say a pressure comprised between 0.6 bar and 1.1 bar.

The epilame substrate is then removed from the enclosure.

Optionally, after the pressure in the enclosure has been reduced and the epilame-coated substrate has been removed from the enclosure, the epilame-coated substrate may be thermally treated. For example, the epilame-coated substrate can be heated in the enclosure to a temperature comprised between 250° C. and 90° C., preferably between 30° C. and 80° C., for a period comprised between 1 min and 45 min, preferably between 2 min and 30 min. Such heat treatment allows to improve the anchoring of the epilame agent to the surface of the treated substrate.

The epilame-coating method according to the invention may further comprise, after the surface of the substrate has been contacted with the epilame agent, a complementary cross-linking step. A complementary cross-linking is advantageously made possible by the presence of suitable functional groups of interest provided on the side chains R₅ of the units U.

### EXAMPLES

### Example 1

An epilame agent was produced by random copolymerisation, resulting in a perfluoroether copolymer.

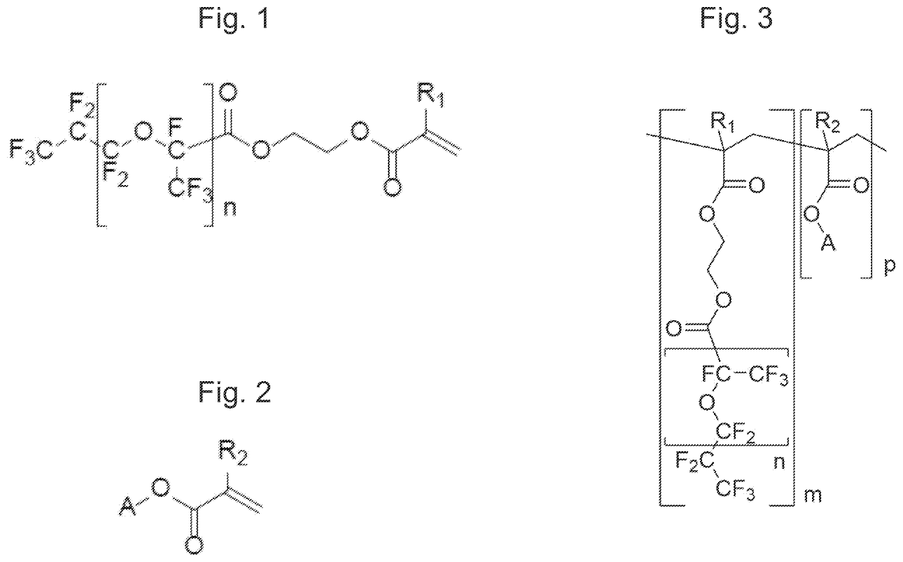

In a first step, a perfluoroether acrylate monomer (“perfluoroether monomer”) was synthesised. Perfluoro-2,5,8,11,14-pentamethyl-3,6,9,12,15-pentaoxaoctadecanoyl fluoride (CAS 13252-15-8) was reacted with 2-hydroxyethyl acrylate (CAS 818-61-1) in the presence of sodium fluoride at room temperature. FIG. 1 shows the monomer obtained, wherein n is 5 and R₁ is H (hydrogen).

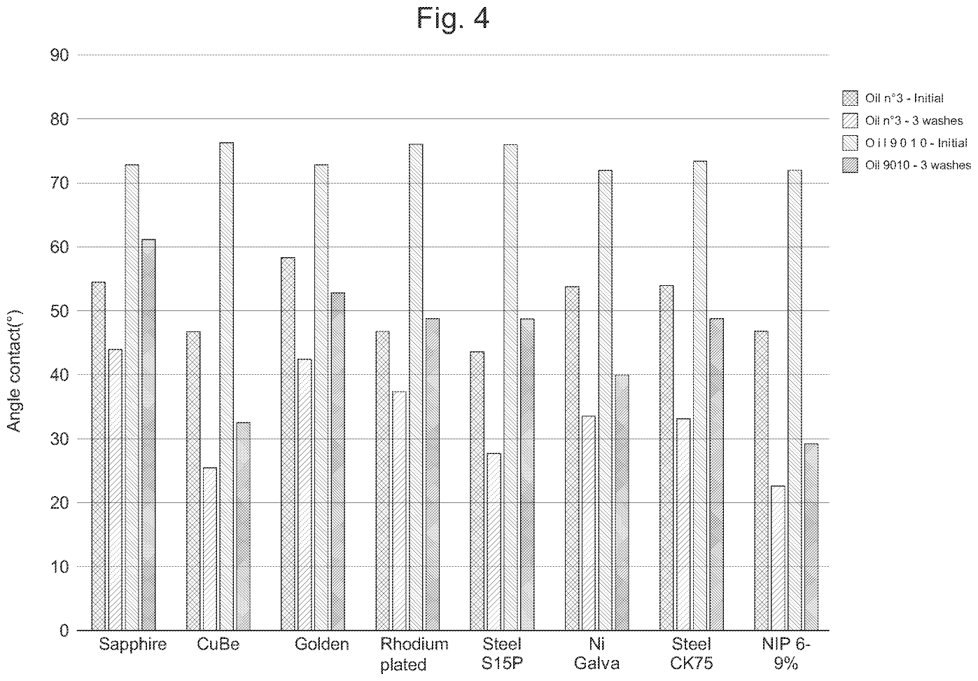

The perfluoroether acrylate monomer was then copolymerised by random copolymerisation with glycidyl methacrylate, shown in FIG. 2, A being CH₂(CHCH₂O) and R₂ being CH₃ (CAS 106-91-2), in the presence of the initiator AIBN. FIG. 3 shows the resulting epilame copolymer, where n is 5, R₁ is H, R₂ is CH₃, A is CH₂ (CHCH₂O) and in an m/p ratio of 9.

### Example 2

Three different epilame agents were deposited on the surface of a steel substrate, which had previously undergone a surface preparation treatment, using an epilame-coating bath. The first epilame is the copolymer synthesised in Example 1. The second epilame agent contains C₆ perfluoroakyl groups, that is to say C₆F₁₃ groups, as epilame groups. The third epilame agent is a competitive epilame agent comprising methyl nonafluoroisobutyl ether (CAS 163702-08-7), methyl nonafluorobutyl ether (CAS 163702-07-6) and a fluoroaliphatic polymer.

Various tests have been carried out to evaluate the properties of epilame agents.

As a first test, the surface energy was determined. The procedure, known to the person skilled in the art, involves measuring (using an OCA 15 contact angle measuring device from Dataphysics) the contact angles of drops of 3 liquids. These are water, diiodomethane and ethylene glycol, each of which has very distinct surface tensions. From the angles obtained, the surface energy is calculated using the Owens, Wendt, Rabel and Kaelble (OWRK) method.

The results are shown in Table 1. The surface of the steel substrate without epilame agent, having undergone a surface preparation procedure, had a surface energy of 34.95 mN/m. All the epilame agents show a reduction in surface energy, and the epilame agent of the invention shows the lowest value. The lower the surface energy, the better the oleophobicity.

TABLE 1
the surface energy of different epilame agents

| Epilame agent | Surface energy (mN/m) |
|---|---|
| Epilame of the invention | 18.44 |
| C₆F₁₃ type epilame | 19.10 |
| Competing epilame | 24.05 |

### Example 3

The three epilame agents from Example 2 were then used (applied) to several substrates with different compositions.

In order to evaluate the performance of the epilame agents, the contact angle was measured with test oil n°3 and with Moebius® oil 9010. Drops of both oils were deposited and the contact angles were measured using an optical device (Dataphysics OCA 15). In order to evaluate the resistance to watchmaking washes, the substrates were washed three times according to a watchmaking wash (amine hydrocarbon solution), followed by measurement of the contact angles.

The target values for each measurement are as follows:
Test oil n°3—initial (before washes): 60°.
Test oil n° 3—after 3 washes: 35°.
Oil 9010—initial: 70°
Oil 9010—after 3 washes: 45°.

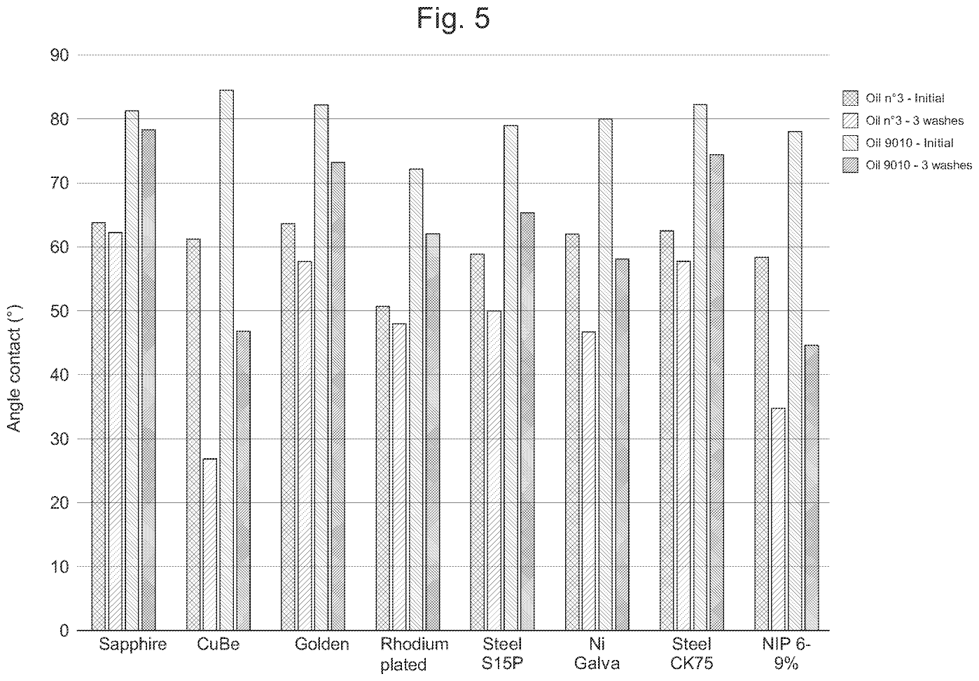

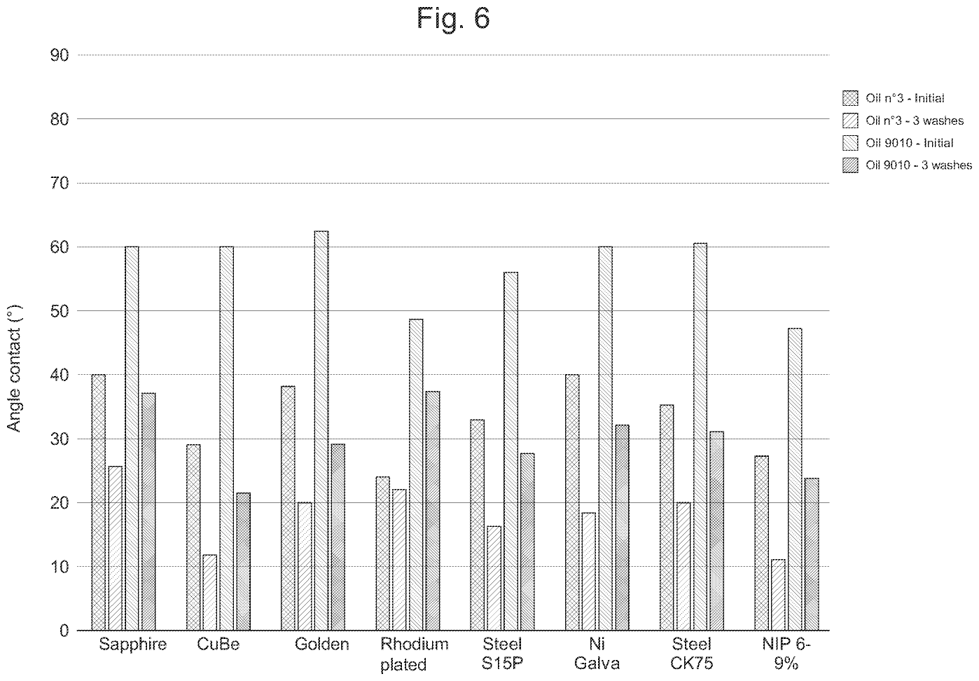

FIG. 4 shows the results on different substrates for the inventive copolymer. FIG. 5 shows the results for the C₆F₁₃ type epilame agent, and FIG. 6 shows the results for the competing epilame agent.

It is clear from FIG. 6 that for none of the substrates are the target values for each oil, before and after 3 washes, achieved. On the other hand, the target values for oil 9010 are achieved with the copolymer according to the invention and the C₆F₁₃ type epilame agent. The target values for oil n° 3 are achieved on certain substrates with these two epilame agents (FIGS. 4 and 5).

1. A substrate comprising a surface at least a portion of which is covered with an epilame agent, wherein said epilame agent comprises at least one compound in the form of a copolymer comprising units M and units N, associated by covalent bonds via their main chains, where
M is 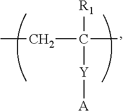
N is 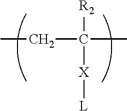
where
R₁ and R₂, which may be identical or different, are H, a C₁-C₁₀ alkyl group, a C₂-C₁₀ alkenyl group, and preferably H or CH₃,
X and Y, which may be identical or different, are spacer arms consisting of a heteroatom or a linear or branched hydrocarbon chain containing at least one heteroatom and comprising at least one carbon atom,
A, which may be identical or different, forms an anchoring group to the substrate,
L, which may be identical or different, is a halogenated ether group according to formula (I) 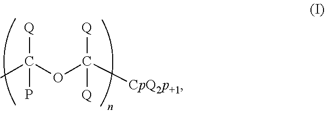
where
Q is a halogen atom,
P, which may be identical or different, is a C₁-C₁₀ alkyl group or a C₂-C₁₀ alkenyl group comprising at least one halogen atom and being linear or branched,
p is chosen between 1 and 4, preferably between 2 and 3, and
n is chosen between 1 and 20, preferably between 1 and 10.

2. The substrate according to claim 1, wherein the copolymer is a random copolymer and the units M and the units N are distributed randomly.

3. The substrate according to claim 1, wherein the copolymer is a block copolymer comprising at least one block of units M associated by covalent bonds via their main chains, and at least one block of units N associated by covalent bonds via their main chains, said blocks being bound together by covalent bonds via their main chains in linear sequences.

4. The substrate according to claim 1, wherein L is an ether group which is at least a partially fluorinated.

5. The substrate according to claim 1, wherein A is selected from the group comprising glycidyl, thiols, thioethers, thioesters, sulphides, thioamides, silanols, alkoxysilanes, silane halides, hydroxyls, phosphates, protected or unprotected phosphonic acids, protected or unprotected phosphonates, amines, ammoniums, nitrogen heterocycles, carboxylic acids, anhydrides and catechols.

6. The substrate according to claim 1, wherein X and Y, which may be identical or different, are selected from the group comprising C₁-C₂₀ ester groups, amide groups and groups derived from styrene, wherein X and Y, which may be identical or different, optionally comprise at least one heteroatom.

7. The substrate according to claim 1, wherein the units N/units M ratio is between 1 and 20.

8. The substrate according to claim 1, wherein the copolymer additionally comprises units V associated with the units M and N by covalent bonds via their main chains, where V is 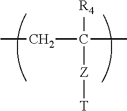
where
R₄, which may be identical or different, is H, a C₁-C₁₀ alkyl group, a C₂-C₁₀ alkenyl group, and H or CH₃,
Z, which may be identical or different, is a spacer arm consisting of a heteroatom or a linear or branched hydrocarbon chain containing at least one heteroatom, comprising at least one carbon atom, and
T, which may be identical or different, is a tracer group arranged to determine the concentration of epilame agent in an epilame-coating bath.

9. The substrate according to claim 8, wherein T, which may be identical or different, is a UV absorber group or a fluorophore.

10. The substrate according to claim 1, wherein its surface, at least a portion of which is covered with the epilame agent, is made of a material selected from the group comprising metals, metal oxides, polymers, sapphire, ruby, silicon, silicon oxides, silicon nitrides, silicon carbides, diamond like carbon (DLC) and alloys thereof.

11. A method for epilame-coating at least a portion of a surface of a substrate comprising the steps of:
preparing an epilame agent comprising at least one copolymer as defined in claim 10,
preparing the surface of the substrate,
contacting the surface of the substrate with the epilame agent.

12. The method for epilame-coating according to claim 11, wherein the preparation of the epilame agent is carried out by copolymerisation of monomers capable of forming the units M with monomers capable of forming the units N, wherein the monomers selected from the group comprising acrylate, methacrylate, acrylamide, methacrylamide, vinyl and styrene monomers.

13. The method for epilame-coating according to claim 11, wherein the epilame agent comprises at least one copolymer, the epilame agent is prepared by preparing an epilame-coating bath containing the epilame agent, the surface of the substrate is contacted with the epilame agent in the epilame-coating bath, and the method optionally comprises, before contacting, a step of controlling the concentration of epilame agent in the epilame-coating bath by means of the tracer group and, optionally, a step of readjusting the concentration of epilame agent in the epilame-coating bath.

14. The epilame-coating method according to claim 11, wherein the step of contacting the surface of the substrate with the epilame agent comprises the steps of:
placing the substrate and the epilame agent in an enclosure at ambient pressure,
hermetically sealing the enclosure,
CO₂ at a pressure comprised between 25 bar and 74 bar, and at a temperature comprised between 10° C. and 80° C. is introduced into the hermetically sealed enclosure,
reducing the pressure in the enclosure, and
removing the epilame-coated substrate from the enclosure.

15. A use of a copolymer comprising units M and units N, associated by covalent bonds via their main chains, wherein
M is 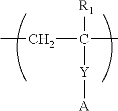
N is 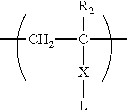
where
R₁ and R₂, which may be identical or different, are H, a C₁-C₁₀ alkyl group, a C₂-C₁₀ alkenyl group, and H or CH₃,
X and Y, which may be identical or different, are spacer arms consisting of a heteroatom or a linear or branched hydrocarbon chain containing at least one heteroatom and comprising at least one carbon atom,
A, which may be identical or different, forms an anchoring group to the substrate,
L, which may be identical or different, is a halogenated ether group according to formula (I) 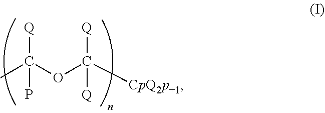
where
Q is a halogen atom,
P, which may be identical or different, is a C₁-C₁₀ alkyl group or a C₂-C₁₀ alkenyl group comprising at least one halogen atom and being linear or branched,
p is chosen between 1 and 10, and n is chosen between 1 and 20, as an epilame agent of at least a portion of a surface of a substrate.

16. A timepiece or a piece of jewellery comprising an element including a substrate according to claim 1.
